(19) United States
(12) Patent Application Publication
(10) Pub. No.: US 2013/0037189 A1
(43) Pub. Date: Feb. 14, 2013

(54) TIRE TREAD FOR A TWO-WHEEL VEHICLE

(71) Applicants: Arnaud Larregain, Thiers (FR); Adam Jara, Clermont-Ferrand (FR); Olivier Muhlhoff, Chateaugay (FR); Olivier Godrie, Riom (FR)

(72) Inventors: Arnaud Larregain, Thiers (FR); Adam Jara, Clermont-Ferrand (FR); Olivier Muhlhoff, Chateaugay (FR); Olivier Godrie, Riom (FR)

(73) Assignees: Michelin Recherche et Technique S.A., Granges-Paccot (CH); COMPAGNIE GENERALE DES ETABLISSEMENTS MICHELIN, Clermont-Ferrand (FR)

(21) Appl. No.: 13/519,849

(22) PCT Filed: Dec. 29, 2010
(86) PCT No.: PCT/EP2010/070852

§ 371 Date: Oct. 11, 2012

(30) Foreign Application Priority Data
Dec. 30, 2009 (FR) 0959664

(51) Int. Cl. B60C 11/11; B60C 11/117

(52) U.S. Cl. 152/209.1

(57) ABSTRACT

Tread for a tyre for a two-wheel vehicle improving grip when running on a usage surface liable to become slippery; this tread comprising blocks (1, 2, 3) separated from one another by grooves (4), each block comprising a contact face (10, 20, 30) intended to come into contact with the usage surface as the tyre is running and lateral faces intersecting the contact face to form edge corners delimiting a contour of the contact face having a geometric shape with at least three branches, each branch (11, 21, 31) ending in a point (110, 210, 310) the angle of which is at least equal to 20 degrees and at most equal to 90 degrees, the branches (11, 21, 31) of each block (1, 2, 3), considered two by two, between them determining setback parts (12, 22, 32), each block (1, 2, 3) being provided with slits (111, 112, 113; 211, 212, 213; 311, 312, 313) terminating at one of their ends in one of the setbacks formed on the face of the block and at a same location at their other end so as to create elementary patterns comprising at least two points of the contact face, the said elementary patterns of one and the same block interacting by contact with one another as they pass through contact with the usage surface. Furthermore, in at least part of the tread, the blocks (1, 2, 3) have orientations that are angularly offset from one another according to their axial position with respect to the equatorial median plane.

### FIELD OF THE INVENTION

The present invention relates to the raised tread blocks or patterns formed on a tread of a bicycle tyre in order to give it good non-skid contact with the ground. It is aimed in particular at improving contact between the tyre and the ground, and more particularly at improving contact with ground that is slippery or has become slippery, such as a very smooth surface, be it natural or synthetic, such as, for example, the coloured lines formed on a road surface, cobbles, particularly when this ground has been wetted by a liquid or is covered with ice.

### PRIOR ART

A bicycle tyre comprises a tread intended to come into contact via a contact area with the road surface on which the bicycle is being ridden. In this contact area it is essential that the material of which the tread is made comes into contact with the road surface eliminating the presence of any intermediate element between the said material and the road surface. A reduction in the contact area connected with the presence of an intermediate element causes a loss of grip which may cause the cyclist to fall off when cornering; incidentally, it is this loss of grip that is one of the most common causes of accidents.

U.S. Pat. No. 5,377,734 describes a tyre for a two-wheel vehicle intended for all-terrain use and the tread of which is provided with raised elements in the form of blocks exhibiting branches, these branches between them forming setback parts. The invention very appreciably improves the grip performance of such a tread.

### Definitions:

The groove-to-rubber ratio of a tread block is equal to the ratio between the area of the hollows (grooves) delimited by the blocks and the total area (the contact area of the blocks and the area of the hollows). A low groove-to-rubber ratio indicates a large contact area for the blocks and a small area of hollows between the blocks.

The equatorial median plane is a plane perpendicular to the axis of rotation and passing through those locations on the tyre that are radially furthest from the said axis.

A block is a raised element formed on the tread and delimited by hollows or grooves and which comprises lateral walls and a contact face intended to come into contact with the road surface. This contact face has a geometric centre defined as being the barycentre or centre of gravity of the face.

### BRIEF DESCRIPTION OF THE INVENTION

The present invention seeks to provide solutions to tread blocks for a tread of a bicycle tyre which improve the grip between the tyre and the road surface, particularly the road surfaces that have become slippery.

To this end, the subject of the invention is a tread block for a tread of a tyre for a bicycle able to improve the grip of this tread when running on a usage surface liable to become slippery either as a result of its surface finish or through the presence of an intermediate foreign body between the said usage surface and the tread, this tread block comprising a plurality of tread block elements that are independent of one another and project out from the tread in the form of blocks separated from one another by grooves. These blocks comprise a contact face intended to come into contact with the usage surface as the tyre is running and lateral faces intersecting the contact face to form edge corners delimiting a contour of the contact face having a shape with several branches, each branch ending in a point the angle of which is at least equal to 20 degrees and at most equal to 90 degrees. Considered in twos, the branches of each block between them determine setback parts, which means parts closer to the geometric centre of the contact face than each of the points. According to a preferred feature, the angle of each point is equal to 80 degrees (plus or minus three degrees). For preference, the contact face is delimited by a contour comprising at least six branches.

Furthermore, each block is provided with slits, or incisions, these slits terminating at one of their ends in one of the setbacks formed on the face of the block and at a same location at the other end so as to create elementary patterns comprising at least two points of the contact face, the said elementary patterns of one and the same block interacting by contact with one another as they pass through contact with the usage surface. In addition, in at least part of the tread, the blocks have orientations that are angularly offset from one another according to their axial position with respect to the equatorial median plane.

Thus, at least some of the points of the blocks are directed in directions that make a zero angle with the circumferential direction on or near the equatorial median plane and others with an angle that increases with increasing distance away from the said median plane. Thus, under cornering, because the rider of the two-wheel vehicle leans in the direction in which he wishes to turn, the active blocks of the tread become those blocks which are situated on the same side with respect to the equatorial median plane, these blocks being furthest away from the equatorial median plane. Thus, thanks to the arrangement according to the invention, the points of the active blocks are oriented substantially perpendicular to the outer boundary of the contact patch, and this is particularly beneficial both for forming a kind of stem to cut through any film of water that there might be (notably in rainy weather) or somehow for gripping the ground via the points.

Moreover, the orientation of the slits is such that these slits are turned through a mean angle which is dependent on the position of the block in which the slits are made with respect to the equatorial plane.

These slits preferably have depths at least equal to 50% of the height of the blocks, this height being measured as being the height of the lateral faces of the said blocks.

The slits soften each block in the radial direction (which means in the direction of its thickness) in its central part and lead to an increase in the number of edge corners in order to increase local pressure points and provide additional drainage in each slit.

For preference, the slits all intersect at the geometric centre of the contact face of each block.

Research conducted by the applicants has demonstrated that it is appropriate to use patterns which not only have intrinsic characteristics in terms of shape and angle as described hereinabove but also are small enough to multiply the locations that bite into the slippery intermediate substance. It has been demonstrated that the patterns described hereinabove are particularly effective if their contact face in the new condition can be inscribed inside a circle of a radius at most equal to 10 millimeters (mm) and preferably of between 2 and 8 mm.

In one embodiment, the groove-to-rubber ratio of this tread pattern is at most 75% and preferably at most 60% in order to encourage the potential extension of grippy contacts with the road.

In one embodiment, the two halves of the tread are symmetric about the equatorial plane.

In one embodiment and on one half of the tread, the slits of these blocks are turned in a direction extending from the block situated near the equatorial plane towards one of the edges of the tread, whereas on the other half of the tread the slits are turned in the opposite direction.

In another embodiment, provision is made for a plurality of blocks provided with at least one slit oriented in the circumferential direction (which means in a direction tangential to a circle centred on the axis of rotation) to be located on the equatorial median plane. This alternative form is beneficial because the steerability of the tyre can thus be improved, which means that the ease with which the tyre best follows a straight path can be improved, particularly on a usage surface that has become slippery.

In a preferred embodiment, the geometric centres of the blocks on either side of the equatorial median plane are positioned on oblique lines that are symmetric about the said equatorial plane. What is meant by placed along oblique lines is that the geometric centres of the blocks are situated on the said oblique lines.

For preference, the angle of the oblique lines along which the geometric centres of the blocks are located is at least equal to 20 degrees and at most equal to 45 degrees with respect to a circumferential direction. More preferably still, this angle is equal to 30 degrees with respect to a circumferential direction. The angle of these lines is equal to the angle made, with the equatorial median plane, by a virtual plane intersecting the surface of the tread, this virtual plane passing through the geometric centres of the blocks.

According to one advantageous alternative form of the invention, the blocks are arranged relative to one another in such a way that at least one point of one block is engaged in a setback of a block that is adjacent along the oblique line. A block is said to be adjacent to another block along an oblique line when these two blocks have their geometric centres on or substantially on this oblique line and they between them delimit one and the same hollow or one and the same groove.

A point of one block is said to be engaged in a setback of an adjacent block when this point is situated at least in part inside the circle within which the contact face of the adjacent block is inscribed. This arrangement may be combined to advantage with any one of the alternative forms set out in this document.

In one advantageous alternative form, provision may be made for the lateral walls of one block to have an appropriate inclination with respect to the contact face of this block in order best to adjust the contact pressures at the edge corners of the contact faces with a view to making it easier for the tread to come into contact with the usage surface after it has passed through the intermediate material. These lateral walls may or may not be perpendicular to the contact face.

Each point of the blocks by becoming progressively crushed under load makes it easier for a force breaking through a film of water present on a usage surface in rainy weather to spread from the point towards the centre of the block. Furthermore, because each edge corner is never strictly parallel to the surface of the ground at the moment the block comes into contact with the ground, a concentration of loading builds up at the biting point and this makes it easier to break through the film of water. Thus, the dry contact which is established as a result produces a significant increase in grip especially since the points of the blocks cling onto any roughness or hollow in the ground forming the roughness of this ground. This same grip-promoting mechanism is repeated when the tyre is running in dry weather over a usage surface that has an intermediate solid body of pulverulent nature present for example.

The invention also relates to tyres for two-wheel vehicles or even to tubular tyres that use a tread according to one of the alternative forms described hereinabove.

Other features and advantages of the invention will emerge from the description given hereinafter with reference to the attached drawings which, by way of nonlimiting examples, show some embodiments of the subject matter of the invention.

### BRIEF DESCRIPTION OF THE DRAWINGS

FIG. 1 is a plan view of a first alternative form of a tread according to the invention;

FIG. 2 is a plan view of a second alternative form of a tread according to the invention;

FIG. 3 is a plan view of a third alternative form of a tread according to the invention.

### DESCRIPTION OF THE FIGURES

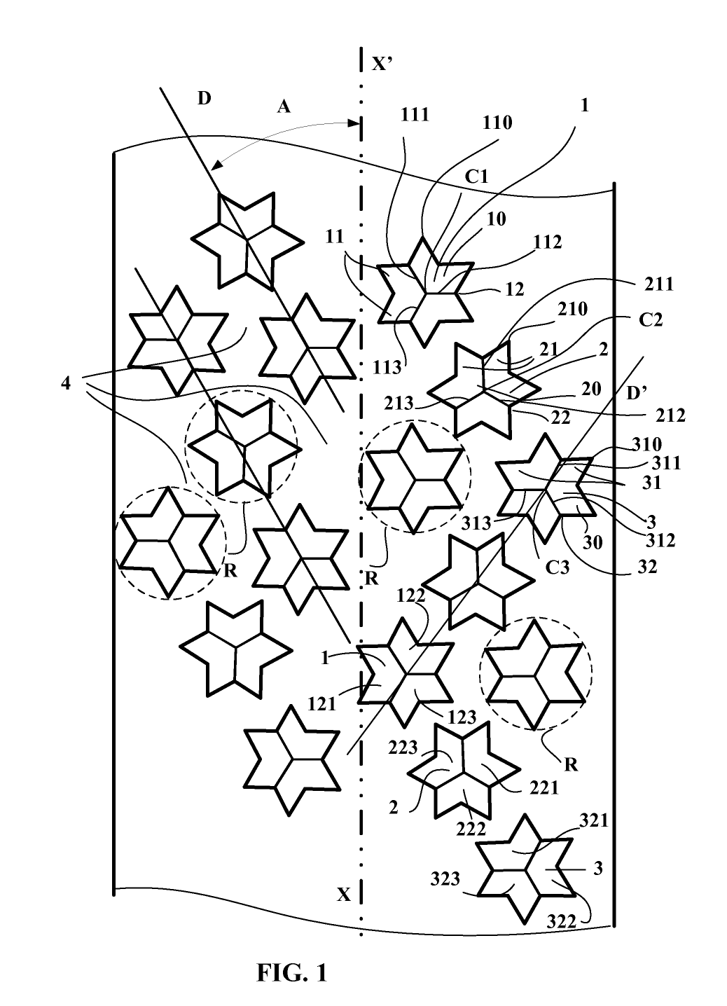

All the alternative forms described with the support of FIGS. 1 to 3 show blocks comprising six branches: of course, these alternative forms can easily be carried across by a person skilled in the art to blocks comprising more than six branches.

FIG. 1 is a partial plan view of a tread according to the invention. According to this first alternative form, the tread for a two-wheel vehicle comprises, on either side of the equatorial median plane (denoted by its line XX′ in the plane of the figure) a plurality of blocks 1, 2, 3 in the shape of regular six-branch stars, these blocks delimiting a plurality of grooves 4. Each block 1, 2, 3 comprises a contact face 10, 20, 30 respectively forming a tread surface of the tread, this tread surface being intended to come into contact with a usage surface on which a tyre provided with this tread runs. Moreover, each block comprises lateral walls that intersect the contact face at edge corners, the lateral walls in this instance being perpendicular to the contact face. The edge corners of one and the same block delineate the contact face in a six-branched star geometry. The blocks 1 are axially closer to the equatorial median plane depicted by the line XX′ in FIG. 1 than are the other blocks 2, 3. The blocks 2 are axially situated between the blocks 1 and the blocks 3, the latter being axially closest to the outside. An axial direction means a direction running perpendicular to the direction XX′ and which corresponds to a direction parallel to the axis of rotation of the tyre.

For each of the blocks 1, 2, 3 each of their branches 11, 21, 31 respectively extends from the geometric centre C1, C2, C3 of the star shape to end in a point 110, 210, 310. Each point 110, 210, 310 forms an angle equal, in this instance, to 60 degrees. Between two points of one and the same block 1, 2, 3 there is a setback 12, 22, 32 respectively, the angle of which is equal to 120 degrees.

Each block 1, 2, 3 is inscribed inside a circle of radius smaller than 10 mm passing through the end of the points (circle R shown in dotted line). Of course, the size of each block 1, 2, 3 could differ according to the axial position in question as need be, while still remaining within the limits of the invention.

Furthermore, each block 1 is provided with three slits 111, 112, 113, of narrow width all intersecting at one of their ends at the geometric centre of the contact face of the block 1 and terminating at their other end in a setback so as to form between them, when considered two by two, an angle of 120 degrees. A narrow width here means that these slits have the ability to close, at least in part, when a tyre provided with such a tread is running so that each block has a contact face free of any discontinuity. The same is true of each block 2 which is provided with slits 211, 212, 213 and for each block 3 provided with slits 311, 312, 313. These slits have depths greater than 50% of the height of the blocks, this height being measured as the height of the lateral faces of the said blocks.

These slits terminate in setbacks of each block so as to create elementary patterns comprising two points of the said block. For example, the block 1 is subdivided into three elementary patterns 121, 122, 123. Each elementary pattern comprises a third point formed by the slits on each elementary pattern. The elementary patterns of one and the same block interact by contact with one another as they pass through contact with the usage surface, thanks to the closing-up of the slits.

Moreover, the blocks 1, 2, 3 and the slits with which they are provided are turned by a mean angle which is dependent on the axial position of the block: while the block 1 in the instance depicted here has two points oriented in the circumferential direction, the blocks 2, which are axially offset from the blocks 1, comprise two points oriented in such a way as to make an angle of 30 degrees with the direction XX′ (the circumferential direction on the tyre). Likewise, the blocks 3 have two points oriented in such a way as to make an angle of 60 degrees with the direction XX′. It is all as if one and the same block pattern had an orientation dependent on the axial position of the said block.

In the instance depicted in this FIG. 1, the blocks are arranged on either side of the tread in such a way as to have their geometric centres aligned on lines D, D′ that make an angle A equal in absolute value to 45 degrees. The arrangement of the blocks on each side of the equatorial median plane is symmetric from a point of view of the angle of the lines on which the geometric centres of the blocks are positioned. However, there is a circumferential offset between the blocks on one side of the tread and the blocks on the other side of the tread.

The invention is thus restricted to the presence of three slits in each six-branch block, it being possible for the person skilled in the art to increase this number until it reaches the number of setback parts on each block. However, in order not to diminish the rigidity of each block too greatly, it is sensible to limit this number of slits per block. It is possible to produce slits the opposing walls of which have interacting reliefs in order to reduce the relative movements between these walls on passage through the contact patch.

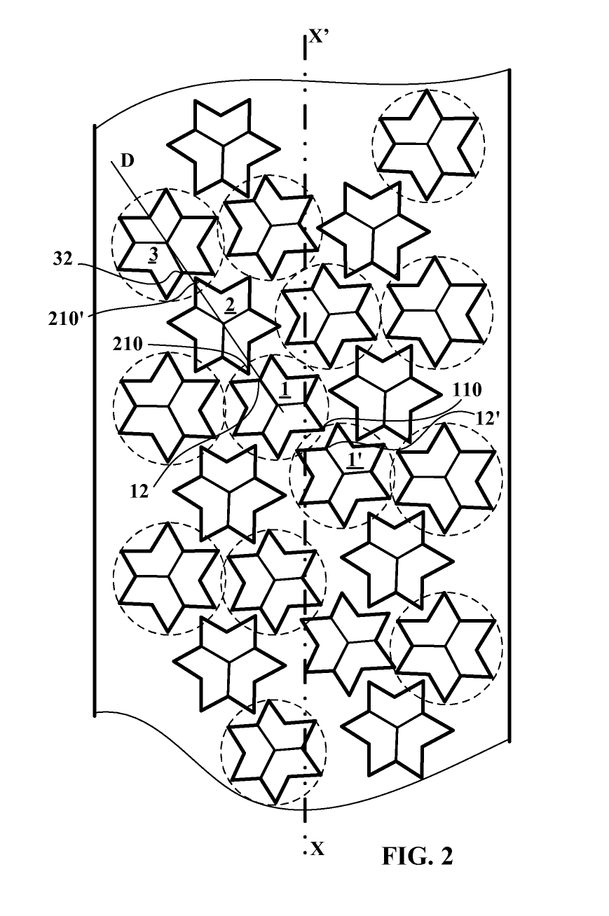

FIG. 2 shows a partial plan view of a tread which again uses the blocks (1, 2, 3) of the first alternative form shown in FIG. 1. One appreciable difference is in a lower groove-to-rubber ratio by comparison with this first alternative form. Specifically, a plurality of blocks have at least one of their points engaged in a setback of a block that is adjacent on an oblique line along which the geometric centres of the said blocks are aligned.

That makes it possible to increase the blocks' density and also make this tread more effective with regard to the retention of solid bodies such as stones. What is meant here by engaged in a setback is that the farthermost part of a point of a block from the geometric centre of the said block lies inside the circle circumscribing the points of an immediately adjacent block.

In the instance depicted, using the same references as those used for FIG. 1 to denote identical structural elements, it is found that along an oblique line D, a block 2 comprises a point 210 engaged in a setback 12 of a block 1 and another point 210′ engaged in a setback 32 of a block 3.

Furthermore, a block 1 on one side of the tread with respect to the equatorial median plane XX′ comprises a point 110 which is engaged in a setback 12′ of a block 1′ situated on the other side of that same equatorial plane.

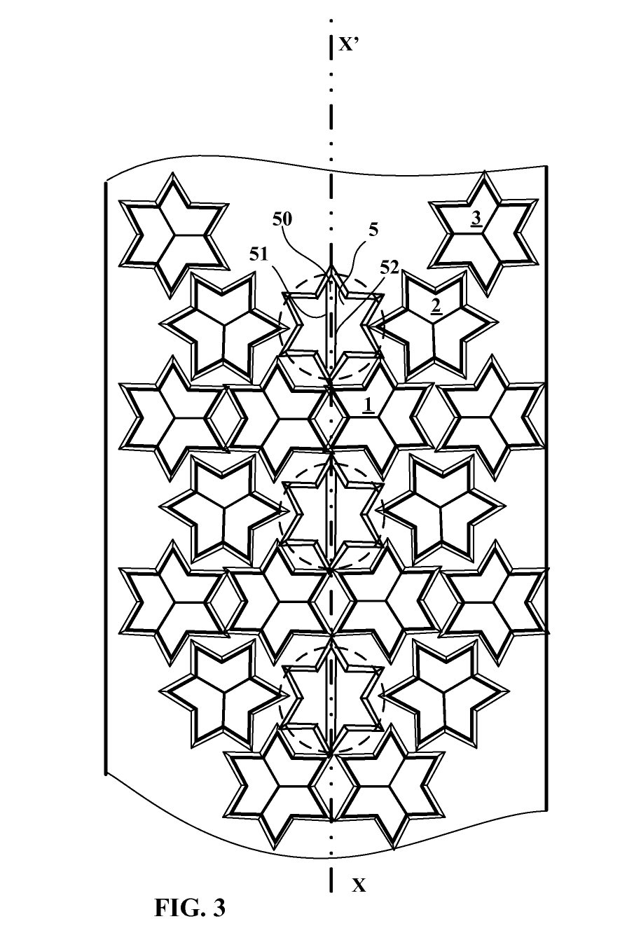

FIG. 3 is a partial view of a third alternative form of a tread according to the invention with which a tyre for a two-wheel vehicle is intended to be equipped, this tyre being of the size 42-622. Once again the same references as those used on the preceding figures are used again here to indicate structural elements that are identical.

This tread is provided with a plurality of blocks 1, 2, 3 having a contact face in the form of a six-branched star, this contact face being, in the new condition, contained inside a circle of radius 8.3 mm. The angle of the points is 60 degrees and that of the setbacks 120 degrees.

The height of the blocks is between 3 and 5 mm. Each block is provided with three slits with a width equal to 0.5 mm and with a depth at least equal to 3 mm, these slits all intersecting at the geometric centre of the faces.

Under its nominal conditions of use, this tyre has a contact patch length of between 60 and 80 mm and a contact patch width of between 25 and 35 mm.

Moreover, the lateral walls of each block form a clearance angle of 10 degrees to a perpendicular to the contact face of the said block. Thus, the surface area of the contact face of each block increases progressively as the tread wears.

Moreover, a plurality of blocks has at least one point engaged in a setback of a block that is adjacent along an oblique line.

Finally, this third alternative form shows the presence of additional blocks 5 which are aligned along the line XX′ of the equatorial median plane, which means to say the geometric centres of which are positioned on this line XX′. These blocks 5 have substantially the same geometry as the blocks 1 axially closest to the equatorial median plane and have two points aligned with the direction XX′. Further, each of these blocks 5 is provided with a groove 50 that is oriented circumferentially, which means in the direction XX′. Thanks to the presence of these grooves that generate circumferential edge corners 51, 52, the ability of the tyre to maintain a straight path when running in a straight line is improved.

Of course, the invention is not restricted to the examples described and depicted and various modifications can be made thereto without departing from the scope as defined by the claims. In particular, the number of points on each block may be greater than six and the dimensions of the points may be different for one and the same block in order to tailor them to the desired performance.

1-13. (canceled)

14. A tread for a tire for a two-wheel vehicle improving grip when running on a usage surface liable to become slippery through the presence of an intermediate foreign body, this tread comprising blocks separated from one another by grooves, each block comprising a contact face intended to come into contact with the usage surface as the tire is running and lateral faces intersecting the contact face to form edge corners delimiting a contour of the contact face having a geometric shape with several branches, each branch ending in a point the angle of which is at least equal to 20 degrees and at most equal to 90 degrees, each point being able to pass through the intermediate foreign body in order to establish direct contact with the usage surface, the branches of each block, considered two by two, between them determining setback parts, which means parts closer to the geometric center of the contact face than each of the points, this tread being wherein each block comprises a contact face having at least six branches and in that each block is provided with slits respectively, these slits terminating at one of their ends in one of the setbacks formed on the face of the block and at a same location at the other end so as to create elementary patterns comprising at least two points of the contact face, the said elementary patterns of one and the same block interacting by contact with one another as they pass through contact with the usage surface, and in that, in at least part of the tread, the blocks have orientations that are angularly offset from one another according to their axial position with respect to the equatorial median plane.

15. The tread according to claim 14 wherein the slits of a block all intersect at the geometric center of the contact face of the said block.

16. The tread according to claim 14 wherein the angular offset between the blocks according to their axial position is equal or substantially equal to 30 degrees.

17. The tread according to claim 14 wherein each block can be inscribed inside a circle the radius of which is at most equal to 10 millimeters.

18. The tread according to claim 17 wherein the radius of the circle is at most equal to 8 mm and at least equal to 2 mm.

19. The tread according to claim 14 wherein it has a groove-to-rubber ratio of at most 75%.

20. The tread according to claim 14 wherein the slits of the blocks are turned in a direction extending from the block situated near the equatorial plane towards the blocks of one of the edges of the tread, whereas on the other half of the tread the slits are turned in the opposite direction.

21. The tread according to claim 14 wherein a plurality of blocks are located on the equatorial median plane, these blocks being provided with at least one groove oriented in the circumferential direction.

22. The tread according to claim 14 wherein the geometric centers of the blocks (1, 2, 3) on either side of the equatorial median plane are positioned on oblique lines that are symmetric about the said equatorial plane.

23. The tread according to claim 14 wherein the angle of the oblique lines along which the geometric centers of the blocks are located is at least equal to 20 degrees and at most equal to 45 degrees with respect to a circumferential direction.

24. The tread according to claim 14 wherein a plurality of blocks have at least one first point engaged in a setback of a block that is adjacent along one and the same oblique line.

25. The tread according to claim 14 wherein the angle of each point is equal to 80 degrees.

26. A tire for a bicycle comprising a tread as defined by claim 14.
